(19) United States
(12) Patent Application Publication
(10) Pub. No.: US 2010/0168502 A1
(43) Pub. Date: Jul. 1, 2010

(54) MODULAR NEONATAL INTENSIVE CARE SYSTEM

(75) Inventors: Stephen E. Delaporte, East Williston, NY (US); Michael J. Gazes, Flushing, NY (US); Thomas J. Keefe, Methuen, MA (US)

Correspondence Address: HESPOS & PORCO LLP, 110 West 40th Street, Suite 2501, NEW YORK, NY, 10018, US

(73) Assignee: WORLD MEDICAL TECHNOLOGIES, LLC, Westlake Village, CA (US)

(21) Appl. No.: 12/649,645

(22) Filed: Dec. 30, 2009

Related U.S. Application Data
(60) Provisional application No. 61/141,708, filed on Dec. 31, 2008.

(51) Int. Cl. A61G 11/00

(52) U.S. Cl. 600/22

(57) ABSTRACT

A modular neonatal intensive care system including an infant incubator, bassinet and frame is provided. The infant incubator of the present disclosure is configured for reducing the overall cost and/or minimizing the amount of power that the neonatal care system or infant incubator draws. A number of the features also make the design more appropriate for the conditions in developing countries. The neonatal care system is also integrated with a hospital bassinet which is made up of a bassinet bed and a frame. The frame for the bassinet acts as both a structural support system and a means for transportation when the neonatal care incubator is attached at the top of the frame.

This application claims priority on U.S. Provisional Patent Appl. No. 61/141,708 filed on Dec. 31, 2008, the contents of which are hereby incorporated by reference in its entirety.

### BACKGROUND OF THE INVENTION

1. Field of the Invention

The present disclosure relates generally to medical systems, and more particularly, to a modular neonatal intensive care system including an infant incubator, bassinet and frame.

2. Description of the Related Art

One of the greatest problems concerning global health today is the death of premature or low-birth-weight infants. Yearly, more than 4 million infants die within a month of birth and more than 96% of these infants are from developing countries. A significant number of those deaths are directly related to an infant's loss of heat and water. In the developed world, the use of infant incubators in hospitals has been the essential solution to this problem and they continue today to provide life support through thermal regulation and a controlled environment, allowing the infant to gain weight to reach its healthy, full development size. In the hospitals of developing countries, however, infant incubators are often too expensive to be acquired or maintained and are often not properly used leading to their malfunction. Additionally, these hospitals typically cannot afford to train or hire skilled workers who can fix and maintain medical equipment that malfunctions, especially incubators, rendering them almost entirely useless. Many other issues also contribute to the difficulty in maintaining incubators in impoverished nations, including limitations on its use of power As a result of these significant problems, there is a tremendous need for an appropriate and affordable incubator that can be effectively used throughout the entire World.

### SUMMARY OF THE INVENTION

A modular neonatal intensive care system including an infant incubator, bassinet and frame is provided. The infant incubator of the present disclosure is configured for reducing the overall cost and/or minimizing the amount of power that the neonatal care system or infant incubator draws. A number of the features also make the design more appropriate for the conditions in developing countries. The neonatal care system is also integrated with a hospital bassinet which is made up of a bassinet bed and a frame. The frame for the bassinet acts as both a structural support system and a means for transportation when the neonatal care incubator is attached at the top of the frame.

According to one aspect of the present disclosure, a neonatal intensive care system is provided including an infant incubator including a base configured for supporting an infant, the base defining a low profile volume including an open top; and an adjustable hood coupled over the open top of the base, wherein in one position the hood collapses completely into the base. The incubator further includes a central support member coupled to at least two portions of the base configured for supporting the hood in a curvilinear shape, the central support member configured for adjusting the hood in a plurality of positions relative to the base.

In one aspect, the hood is formed from a flexible material such as vinyl.

In another aspect, the hood includes a door formed from a rigid material such as an acrylic or resin. In certain embodiment, the door includes at least one handhole.

In a further aspect, the base of the incubator includes a modular, removable heating element for generating heat. In one embodiment, the base includes a low volume chamber for receiving the modular heating element, the chamber being formed from insulated and reflective walls to prevent heat loss. In another embodiment, the base further includes a channel for recycling heat from the incubator back to the heating element.

In yet another aspect, the base of the incubator further includes a modular, removable temperature control interface for controlling the temperature of the incubator.

In another aspect, the system includes a uninterruptible power supply (UPS) for providing power to the heating element and the temperature control interface.

In a further aspect, the base includes a portion storing a phase change material (PCM) for supplying heat to the incubator upon loss of power being provided.

According to another aspect of the present disclosure, the base includes a first portion and a second portion, the first portion slides into the second portion is a first, non-operational position and the first portion fully extends from the second portion in a second operational position.

In one a further aspect, the system further includes a frame for transporting the incubator, the frame including a support member positioned at a top portion of the frame for supporting the incubator and a bassinet, wherein the support member of the frame is further configured to support the bassinet in various positions when the incubator is not in use.

According to a further aspect of the present disclosure, an infant incubator is provided including a generally rectangular base configured for supporting an infant, the base including a bottom wall and at least three side walls defining a low profile volume including an open top; a hood coupled over the open top of the base configured from a flexible material; and a central support member coupled to at least two portions of the base configured for supporting the hood in a curvilinear shape, the central support member configured for adjusting the hood in a plurality of positions relative to the base, wherein in one position the hood and central support member collapses completely into the base. The base further includes a low volume chamber for receiving a modular heating element, the chamber being formed from insulated and reflective walls to prevent heat loss; and a channel for recycling heat from an internal cavity of the incubator back to the heating element in the chamber enabling the heating element to operate at a lower temperature to conserve power.

In one aspect, the hood further comprises a door formed from a rigid material rotatably coupled to the central support member by at least one hinge.

In another aspect, the incubator further includes a control interface disposed on the base for controlling functions of the incubator, wherein each function is illustrated by a non-text graphic.

### BRIEF DESCRIPTION OF THE DRAWINGS

The above and other aspects, features, and advantages of the present disclosure will become more apparent in light of the following detailed description when taken in conjunction with the accompanying drawings.

FIG. 1 is a perspective view of a neonatal care infant incubator in accordance with an embodiment of the present disclosure;

FIG. 2 is a perspective view of a neonatal care infant incubator in accordance with another embodiment of the present disclosure;

FIG. 3 is a perspective view of a neonatal care infant incubator in accordance with a further embodiment of the present disclosure;

FIG. 4 is a perspective view of a neonatal care infant incubator in accordance with another embodiment of the present disclosure;

FIG. 5 is an isometric view of the neonatal intensive care system illustrating the infant incubator being attached and supported by a bassinet frame, providing transportation and dual functionality between the infant incubator and the bassinet;

FIG. 6 shows an isometric view of the bassinet bed and frame when the infant incubator has been detached from the frame, and the bassinet bed is implemented at the top of the infant incubator;

FIG. 7A shows a side view of the infant incubator in an opened state where hood material is pulled taught over a central support member and FIG. 7B shows a side view of the infant incubator in its fully collapsed position with the hood material flattened making it an ideal position for storing or shipping in accordance with one embodiment;

FIG. 8A shows a side view of the infant incubator in an opened state where the hood material is pulled taught over the central support member and FIG. 8B shows a side view of the infant incubator in its fully collapsed position with the hood material flattened making it an ideal position for storing or shipping in accordance with another embodiment;

FIG. 9 is a block diagram of an uninterruptable power supply in accordance with the present disclosure;

FIG. 10 is a block diagram of the incubator circuitry in accordance with the present disclosure;

FIGS. 11A and 11B illustrates heat flow throughout the infant incubator in accordance with the present disclosure;

FIG. 12 illustrates the modular component feature of the incubator with an exploded detail view;

FIG. 13 shows an infant incubator according to another embodiment where FIG. 13A illustrates the incubator in a fully closed position and FIG. 13B illustrates the infant incubator in an open functional position; and

FIGS. 14 illustrate a sequence of operating an infant incubator, where the a hood of the infant incubator is shown in a fully expanded state in FIG. 14A, allowing more space for medical practitioners to maneuver and care for the infant, FIG. 14B shows an intermediate state of the hood and FIG. 14C shows the hood in a collapsed state in allowing for heat and power conservation.

To facilitate understanding, identical reference numerals have been used, where possible, to designate identical elements that are common to the figures, except that alphanumerical suffixes may be added, when appropriate, to differentiate such elements. The images in the drawings are simplified for illustrative purposes and are not depicted to scale.

The appended drawings illustrate exemplary embodiments of the present disclosure and, as such, should not be considered as limiting the scope of the disclosure that may admit to other equally effective embodiments. Correspondingly, it has been contemplated that features or steps of one embodiment may beneficially be incorporated in other embodiments without further recitation.

In some embodiments, particular method steps of the discussed methods are performed in the depicted order. In alternate embodiments, in the respective methods, at least two method steps or portions thereof may be performed contemporaneously, in parallel, or in a different order.

### DETAILED DESCRIPTION OF THE PREFERRED EMBODIMENTS

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “controller” or “control circuitry” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage, programmable logic or other device or devices.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The word “exemplary” is used herein to mean “serving as an example, instance, or illustration.” Any configuration or design described herein as “exemplary” is not necessarily to be construed as preferred or advantageous over other configurations or designs. Herein, the phrase “coupled with” is defined to mean directly connected to or indirectly connected with through one or more intermediate components. Such intermediate components may include both hardware and software based components.

A modular neonatal intensive care system including an infant incubator, bassinet and frame is provided. The neonatal care system or infant incubator of the present disclosure is configured for reducing the overall cost and/or minimizing the amount of power that the neonatal care system or infant incubator draws. The infant incubator of the present disclosure provides a significant reduction in the amount of material used compared with a typical incubator designed for first-world hospitals (less than 50%) which ultimately reduces its overall cost. This is due largely in part to the fact that a flat base is provided for housing the electronics, heating element, and the infant's bed. Beyond the base, a central support member is provided to allow either a mechanically functional hood with molded parts to be attached and integrated, or, as an inexpensive alternative, a fully transparent vinyl hood can also be used when it is pulled taut over the central support bar and attached with snaps under the upper bordering edges of the base. This ultimately allows separate hoods to be used depending upon what a clinic or hospital can afford. Simple locking mechanisms, e.g. snaps, and the light weight of each type of hood make the hood easy to replace if something malfunctions. Implementing transparent vinyl for the hood is significantly cheaper than using rigid material, e.g., molded ABS resins and acrylic based parts, and due to the nature of the hood's flat curved geometry, the vinyl material tapers off by the sides, where extra material is not needed, while still providing enough volume at the center where the infant is located. Having a central support member with a mechanically foldable hood, or a vinyl material based hood, also allows the hood to be easily packaged and shipped.

When the infant incubator's central support member is fully collapsed, the infant incubator is reduced to the 5 inch height of its base. This also allows the infant incubator to be easily shipped and stored. Handholes in the hood also present advantages in that they are ergonomically designed giving the medical practitioner an optimal amount of movement inside the infant incubator to manipulate the infant. The handholes are also designed with a geometry and location that accommodates the curvilinear shape of the hood further optimizing the entire design. For the mechanically functional hood, a door opening is also provided to allow medical practitioners the ability to move the infant in and out of the incubator with very little difficulty, which is especially useful in the case of emergencies.

To take full advantage of a low-volume design without losing heat or comprising other needed features which require extra volume, such as when a squeeze-bag is needed inside the infant incubator, the hood is configured to be adjustable into various positions during use. The hood can be expanded upward through a telescoping element integrated with the central support member when the extra volume is temporarily needed. The infant incubator hood can then be collapsed back to its original position to maintain its low-volume. In one embodiment, extra vinyl material is also located just below the incubator bed and is attached to extension springs, further providing enough material for the hood to be fully expanded and to allow for a uniform contour.

Portholes are located at each of the four corners of the hood of the infant incubator to allow the temperature probes or any other kind of peripheral instruments, such as a feeding tube or an oxygen monitor to be brought into the infant incubator.

The infant incubator is also integrated with a hospital bassinet which is made up of a bassinet bed and a frame. The frame for the bassinet acts as both a structural support system and a means for transportation when the infant incubator is attached at the top of the frame. This allows the doctor or nurse to place the baby in the bassinet bed when the infant incubator is no longer needed. The infant incubator can then be stored or used by another infant. If there are no more bassinets available for transportation or structural support, the incubators flat base allows it to be located on top of a table with no limitations on its functionality. Two handlebars are also located at the ends of the infant incubator to allow for ease of transportation when the incubator is being moved, especially from an ambulance to a hospital. Handles are additionally provided through openings at the sides of the bassinet bed in four locations to better optimize its overall handling. This allows for an advantage over the typical bassinet bed which does not offer anything more than a small lip around its edge for handling. These novel handle designs are useful for not only when the angle of the bed needs to be repositioned, but for carrying it to a new location, such as to its storage position in the lower part of the frame.

The frame includes structural elements for supporting other necessary items depending on the situation, e.g., oxygen tanks, medical supplies, a power source for the incubator (a battery). Casters with 5 inch wheels are used to allow for a greater load to be carried on the frame. This is especially important because of the weight of the batteries and the infant incubator. Larger wheels also allow the incubator to be easily transported from one location to another. Two casters located at the corners of the frame have locks to allow for extra stability and to allow the infant incubator and bassinet to remain in a fixed position.

An online UPS (uninterruptible power supply) provides emergency battery-backup power, immunity to power quality issues, and allows for universal power input. All loads are run directly from an emergency back-up battery. This has many advantages: (a) Upon loss of power, the incubator transitions seamlessly from AC wall-power to battery power, whether the outage is for several hours, several seconds, or just a power sag; (b) The battery buffers the incubator electronics from dangerous power spikes and surges; (c) The incubator operates on any AC voltage from 90 VAC to 250 VAC, because any voltage in that range is converted to the same 15 VDC supply; (d) All wiring is low-voltage, increasing infant safety; (e) The heating element is designed for battery operation, eliminating the need for an AC inverter, therefore, when operating in emergency battery mode, electricity is converted to heat with 100% efficiency.

While conserving power is not a concern for infant incubators designed for first-world hospitals, it is a crucial issue when dealing with the intermittent power prevalent in developing countries. Besides the obvious benefit of energy conservation and reduced operating costs, a low-power design is essential for operating the infant incubator from a battery. Power outages often last as long as 12 hours, so it is essential that the incubator's emergency back-up battery can last this long. Minimizing power consumption means longer battery runtime, and smaller, cheaper batteries. A low-power design also allows for off-grid use, such as in rural areas. The following paragraphs describe the specific thermal-efficient features that reduce the incubator's power requirements. The cumulative effect of these thermal-efficient features is to reduce the required heating element power from 400 or 500 Watts (typical of incubators by Ohmeda, GE, and Draeger) to less than 100 Watts. This allows for 12-hours of battery back-up on a 20 Amp-hour lead-acid battery, roughly one-fourth the size of a standard car battery.

To minimize power consumption, it is important that none of the electrically generated heat is wasted. This is accomplished by insulating the heating unit, maximizing the time that incoming air is in contact with the heat source, minimizing losses at the infant. Rather than blow air past the heating element at the inlet, the air is pushed through a long, heated path. This allows the heating element to operate at a lower temperature (and therefore lower power) because the heating element has more time to conduct heat to the air. Heat loss at the infant is minimized in three ways. First, the use of a double-walled hood can prevent heat loss by infrared radiation. Second, low air-velocity at the infant minimizes evaporative heat loss from the infant's body. Lastly, heat recovery ventilation recycles heat from the exhaust air.

To further augment the low-power design, a phase change material (PCM) for energy storage is incorporated into one embodiment. Typical emergency power supplies operate by storing the incoming AC power as an electrochemical potential in a battery. However, since the bulk of the incubator's electrical power is used for generating heat, the ideal solution is to convert the incoming power directly from AC electrical energy to heat. A brick of PCM inside the base of the incubator uses the incoming AC to change from solid to liquid. When power is lost, the PCM brick releases heat as it changes from a liquid back to a solid. Until the phase change is complete, the brick maintains a constant temperature. This constant temperature source provides a baseline for heating the incoming air such that the electrical heating element only drains the battery as needed to augment this PCM heat. This innovation further decreases battery size and cost, increases the amount of time the infant incubator can operate without AC power, and makes the infant incubator suitable for use in rural, off-grid areas. While electric heating is the only practical solution for a hospital environment, the design can be modified to heat the PCM by other means, such as solar heating, or boiling water. These methods are more appropriate to small rural areas where the infant incubator is needed for home use. In such a design, the PCM brick is the only heating source. Electrical power is only needed for the temperature sensors, control panel, and fan. This micropower version of the infant incubator could be powered by a foot treadle device, or a small solar panel.

An intuitive temperature control interface that maintains the infant's thermal neutral zone without complicated servo controls is provided. Temperature control is achieved via two LCD screens, up/down/toggle buttons, and three temperature probes: an air-temperature monitor embedded in the infant incubator, and two optional infant temperature probes. Out of the box, without requiring any user configuration, the incubator displays the air temperature on one LCD screen, and the air temperature set-point on the other LCD screen. Pressing the up/down buttons, the user controls the incubator air temperature set-point. Medical personnel, who prefer to adjust the incubator air temperature based on a weight/age nomogram, and to take temperature manually with a thermometer, will find this interface intuitive. Adding one temperature probe to monitor the infant's temperature, medical personnel press the “toggle” button to switch between the air-temperature readout and the infant-temperature readout. This allows medical personnel to monitor the infant's temperature without a thermometer.

Four levels of protection prevent the incubator from overheating: (1) The controller monitors the air temperature via an air temperature sensor, and limits the air temperature to a maximum of 39° C.; (2) The controller monitors the heater temperature via a sensor mounted directly to the heating element, and limits the heating element temperature to 105° C.; (3) In case the sensor fails, a heater-mounted thermal switch opens when the heater temperature rises above 105° C.; and (4) In case the thermal switch fails, a heater-mounted thermal cutoff opens when the heater temperature rises above 120° C.

The control panel has a minimalist layout that is intuitive and easy to understand. Each function is illustrated by a graphic, and LEDs illuminate the graphics to indicate which function is active. This allows the incubator to be used in non-English-speaking countries. An infant graphic and an incubator graphic indicate which temperature is displayed on the LCD screen. A temperature-ready graphic provides an immediate indication that the air temperature is in the desired range. A battery graphic and an AC power graphic indicate the main power source. A power-on/off graphic and a universal warning signal graphic indicate when the incubator is powered on and is functioning properly. An LED array indicates the battery's state of charge.

Maintenance is one of the greatest challenges for hospitals in developing countries These hospitals lack trained repair technicians and/or the supply chain to replace parts. To address this issue, each of the printed circuit boards (PCBs) is designed to be removed and replaced without any tools or training. Replacement is analogous to changing a light bulb. The PCBs and the heating unit are mounted in assemblies that are easy to remove from the incubator. The entire assembly is returned to the distributor, and a replacement assembly is inserted in its place. If either the control panel or the control unit fails, the entire display shuts down and the incubator appears to be powered off. If the heating unit fails, a warning signal is illuminated on the control panel, and a second LED is illuminated on the faulty heating unit. At a glance, it is clear which assembly requires replacement.

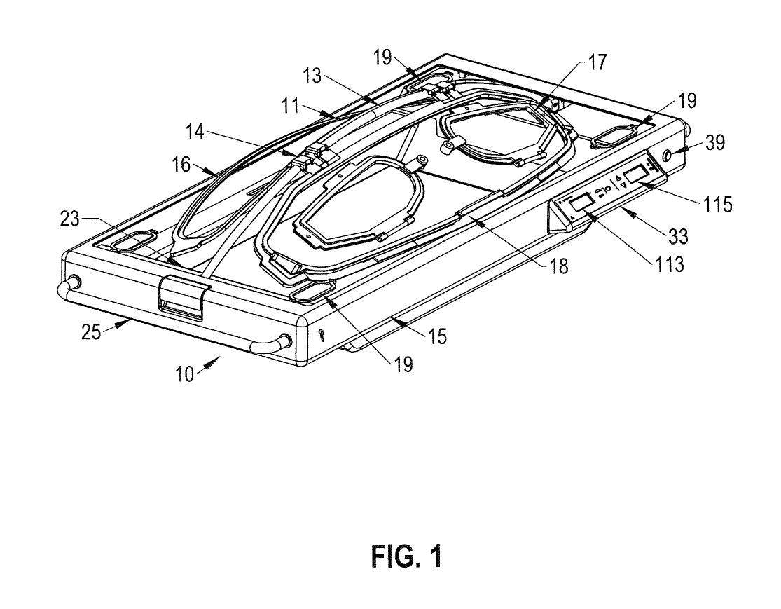

Referring to FIG. 1, neonatal care system or infant incubator 10 includes an inexpensive, transparent hood 11 made up of a combination of rigid material (such as molded ABS resin and acrylic parts) coupled with a malleable material (such as a vinyl or nylon canvas material) which is used to provide an easily foldable seal and a connection between each of the rigid parts. This hood 11 can also be easily replaced. The hood 11 has a curvilinear geometry that tapers on its sides to optimize the volume at the center where the infant is located, while minimizing the overall use of material for the hood 11. The hood 11 includes a front door opening 18 and a back window 16 having a similar geometric shape as the front door opening 18. In one embodiment, the front door opening 18 and back window 16 are formed from a rigid material such as acrylic and the remaining portions that fill in the gaps between the rigid portions are formed from a malleable material such as vinyl or nylon canvas material. The front door opening 18 can be lifted and rotated into an open position from a set of hinges 14 attached to the middle section of a central support member 13 allowing the front door opening 18 to easily rest upon the back window 16 when in a fully opened state. Allowing the front door opening 18 to be rotated backwards also decreases the chances of someone leaning against it which further diminishes the chances of a broken part. Alternatively, the hood 11 could also be made entirely out of a malleable material, such as DEHP-free vinyl, which can be collapsed and folded when the infant incubator is being stored or shipped. Regardless of the materials used for the hood, the hood may be constructed from double-walled material to reduce heat loss.

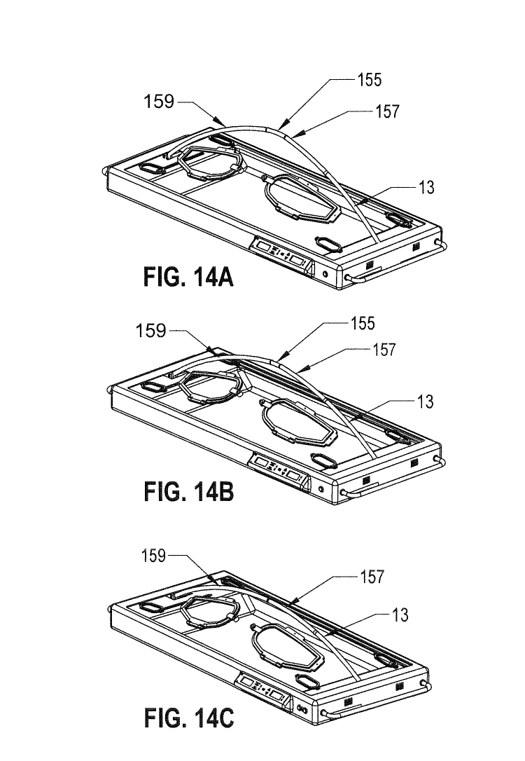

A central support member 13 provides structural support for the hood 11 and can be expanded upwards to allow for greater volume inside the infant incubator 10, such as when a squeeze bag is needed for the infant. When the hood 11 is in a collapsed or lower position, a low internal volume allows the incubator 10 to draw less power and conserve heat, making it easier to manage when power is not available. The central support member 13 is coupled to at least two portions of the base and is configured for supporting the hood 11 in a curvilinear shape. The central support member 13 is configured for adjusting the hood 11 in a plurality of positions relative to the base 15, as will be described below in relation to FIG. 14.

The central support member 13 can also be fully rotated down, flat against the base 15, allowing the infant incubator 10 to be easily stored or shipped. The generally rectangular base is configured for supporting an infant, the base including a bottom wall and at least three side walls defining a low profile volume including an open top for which the hood is disposed over. The base 15 acts as a housing for the heating element and the electronics which will be described below. The base 15 also provides a base-plate for the infant bed.

Ergonomically designed handholes 17 are provided and allow for optimal movement and use by the medical practitioner when manipulating the infant inside the infant incubator 10. Portholes 19 are located at each of the four corners of the hood 11 of the infant incubator 10 to allow the temperature probe or any other kind of peripheral instruments, such as a feeding tube or an oxygen monitor to be brought into the incubator 10. Additional handles 25 are provided at the incubators sides for ease of use when transporting the incubator 10.

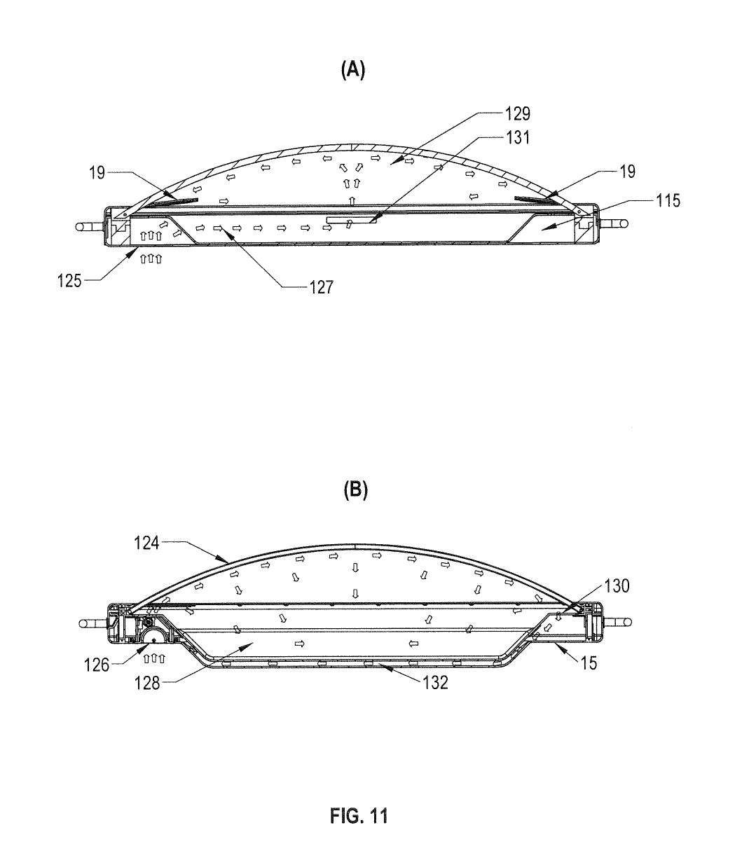

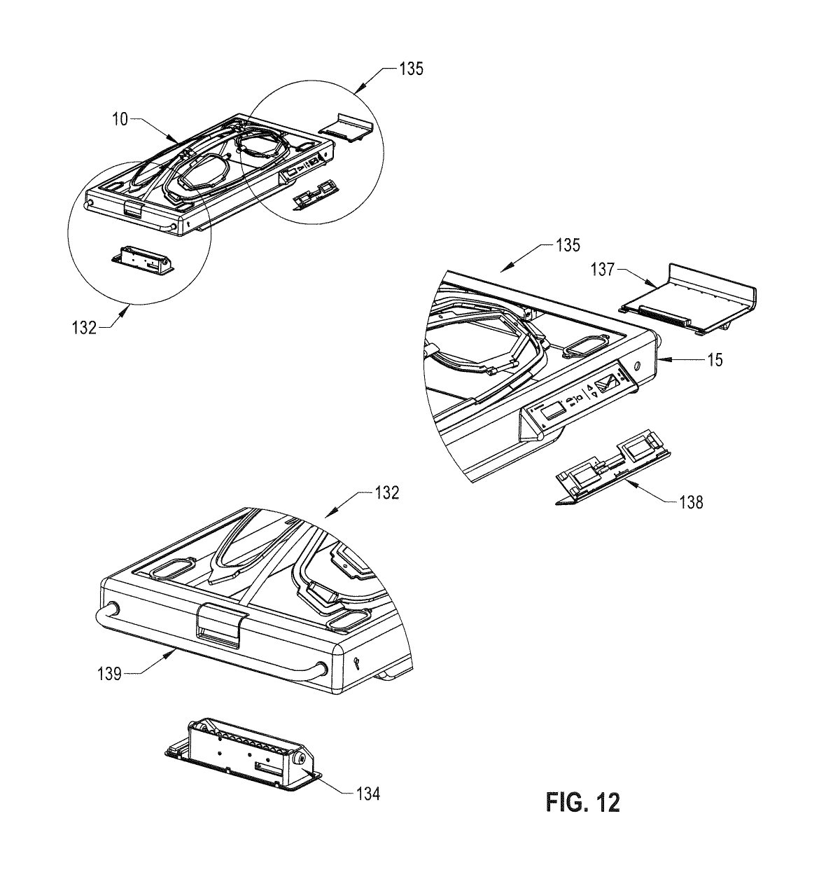

An intuitive temperature control interface 33 is provided that maintains the infant's thermal neutral zone without complicated servo controls. The control panel 33 also has a minimalist layout which contributes to its ease of use. Temperature control is achieved via two LCD screens up/down/toggle buttons. The infant incubator displays the air temperature on one LCD screen 113, and the air temperature set-point on the other LCD screen 115, the details of which will be described below in relation to FIG. 10. Easy to understand graphics are used instead of words to indicate different functions of the incubator making it more universal to users from different countries who speak different languages. At least one connector 39 is provided for infant temperature probes. An air-temperature monitor is also embedded within the infant incubator. The electronics are located on removable cards and allow medical personnel to easily remove and replace a circuit board that has malfunctioned, the details of which will be described below in relation to FIG. 12. Additionally, a heating source propagates heat flow from an opening 23 at the left side of the incubator base 15, the details of which will be described below in relation to FIG. 11.

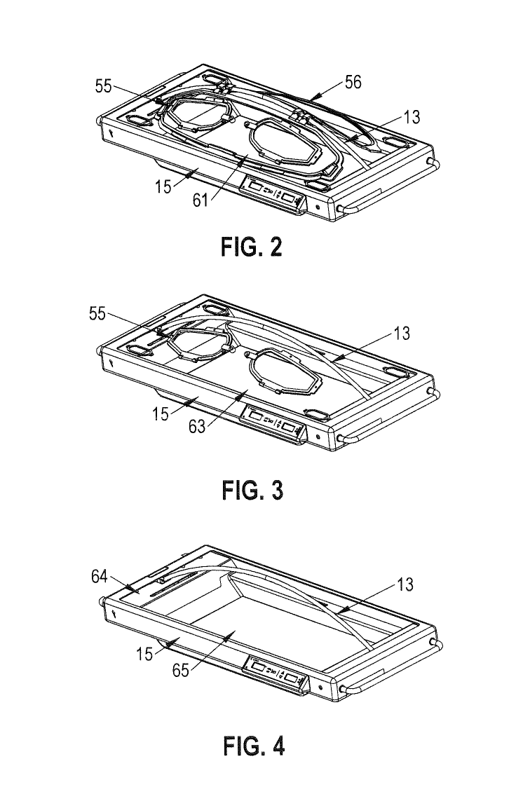

Referring to FIGS. 2-4, various embodiments of the incubator are shown. In FIG. 2, the incubator is constructed with an acrylic hood disposed over the base 15. The hood is supported by central support member 13 and includes front door 61 and rear door 56, the front door 61 having two handholes 55. In FIG. 3, the same base 15 and central support member 13 support a vinyl hood 63. In this embodiment, the vinyl hood 63 includes two handholes 55. Lastly, in FIG. 4, the hood 65 is constructed as an all vinyl hood. It is to be appreciated that in all the embodiments shown the base 15 and central support member 13 are of similar construction. In this manner, any of the exemplary hoods shown and described may be used with such a base and can be swapped depending on what a particular hospital or clinic can afford.

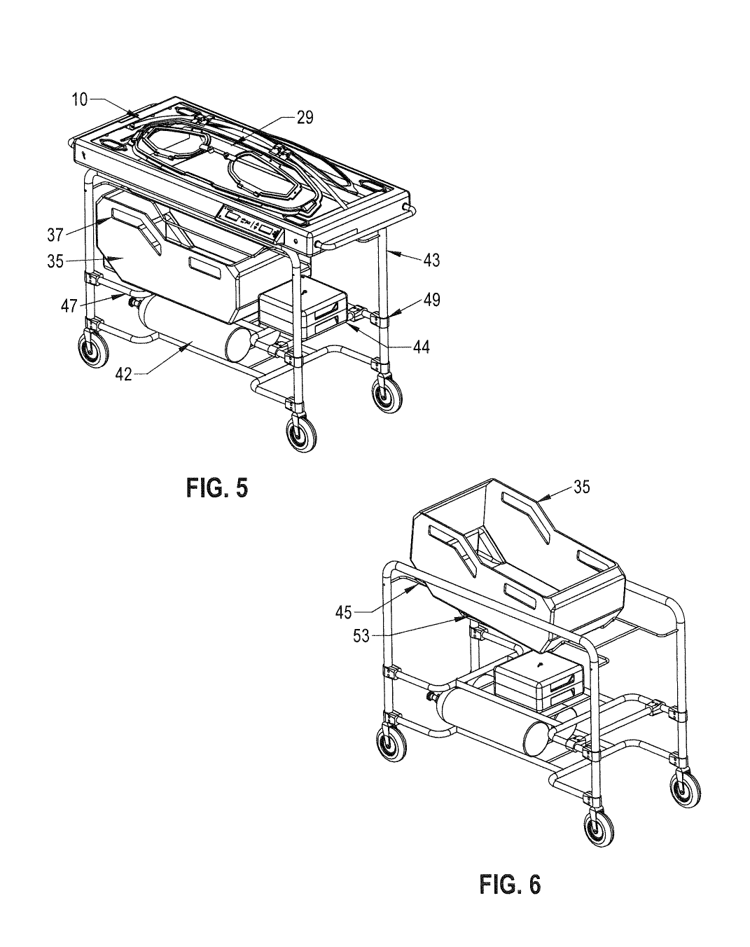

Referring to FIGS. 5 and 6, a basinet bed 35 and frame 43 are also provided. Opening 37 at the sides of the bassinet bed in four locations optimize the overall handling of the basinet bed 35. The frame 43 provides a structural support for the both the infant incubator 10 and the bassinet bed 35. The frame 35 also provides a means for transportation and support for other functional parts, such as the backup battery supply and oxygen tanks 42. A battery 44 of the UPS (uninterruptible power supply) is housed at the base of frame 49. A battery indicator and level readout are configured with the AC power indicator at right side of the control panel 33. Additional frame elements 45 are located at the top of the bassinet frame 43 to provide structural support for when the bassinet bed 35 is being used. The bassinet bed 35 can be stored at the base 47 of the frame when the infant is located in the infant incubator 10. When the bassinet 35 is in use at the top of the frame 53, it can be positioned at different angles as shown in FIG. 6.

The online UPS (uninterruptible power supply) provides emergency battery-backup power, immunity to power quality issues, such brownouts and voltage surges, and allows for universal power input. Phase change material 29 is located inside the incubator 10 to conserve heat loss when the incubator is running off the battery.

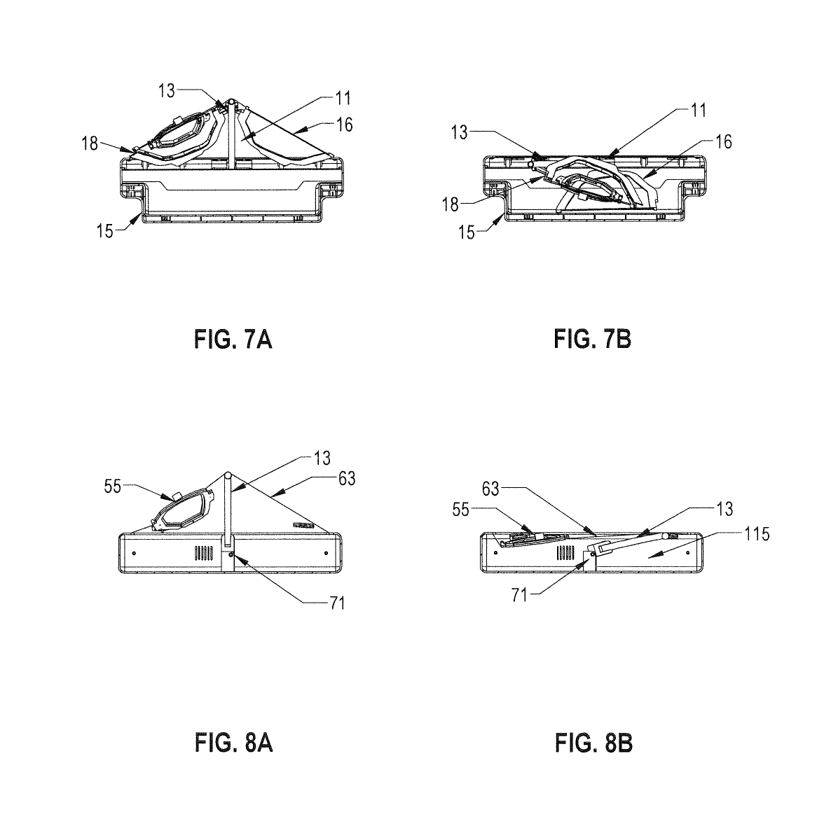

Now referring to FIGS. 7A and 7B, the infant incubator is shown in an open state in FIG. 7A and a closed state in FIG. 7B. It is to be appreciated that the embodiment shown in FIGS. 7A and 7B is similar to the incubator shown in FIGS. 1 and 2 among others. FIG. 7A illustrates a side view of the infant incubator in the open state showing front door opening 18, back window 16, central support member 13 and acrylic hood 11. As shown in FIG. 7B, the hood 11 and its components are positionable so the hood collapses completely within the generally rectangular volume defined by the base 15.

Now referring to FIGS. 8A and 8B, the infant incubator is shown in an open state in FIG. 8A and a closed state in FIG. 8B in accordance with another embodiment. It is to be appreciated that the embodiment shown in FIGS. 8A and 8B is similar to the incubator shown in FIG. 3, among others. FIG. 8A illustrates a side view of the infant incubator in the open state showing handholes 55, central support member 13 and DEHP-free vinyl hood 63. Also shown is central support member end-joint 71. As shown in FIG. 8B, the hood 63 and its components are positionable so the hood collapses completely within the generally rectangular volume defined by the base 115. The DEHP-free vinyl, or alternative material, hood 63 is flattened when the infant incubator is in a fully collapsed state. The handholes 55 are flattened to the top of the base 15 when the infant incubator 10 is in a fully collapsed state. Also shown are the central support member's end-joint 71 and central support member 13 when the incubator is in a fully collapsed state. While in its closed state, the infant incubator can be stacked, one on top of another, for when they are stored or shipped.

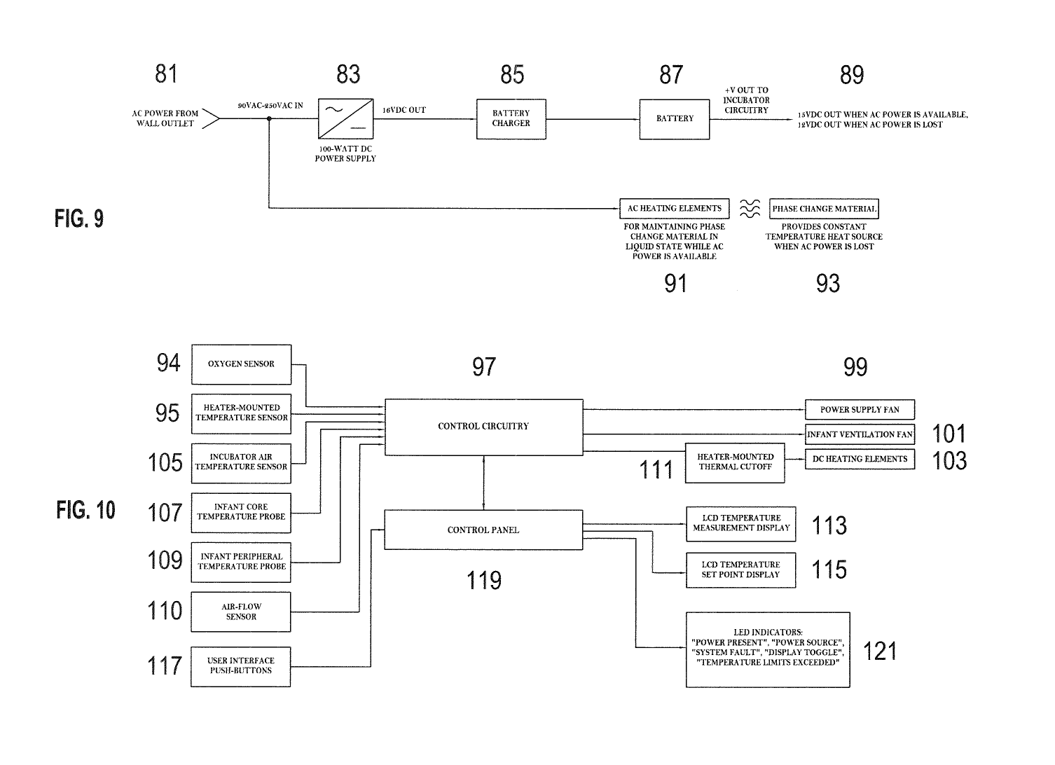

FIG. 9 is a block diagram of an uninterruptable power supply in accordance with the present disclosure. The power supply will receive AC power 81 for example from a conventional wall outlet. The AC power will be fed into a DC power supply 83 which will subsequently feed battery charger 85. The battery charger 85 is coupled to battery 87, e.g., a sealed lead-acid battery, for powering the electronic components of the incubator which are shown in FIG. 10. Reference numeral 89 indicates the available power output under various conditions, e.g., when AC power is available or lost.

The infant incubator further includes AC heating elements 91 coupled to the AC power source 81. The heating elements 91 are provided for maintaining phase change material 93 in a liquid state while the AC power is available. The phase change material 93 provides a constant temperature heat source when AC power is lost as described above. It is to be appreciated that the phase change material 93 may be disposed within a cavity of the base or may be a separate component which may be laid onto a upper surface of the base.

FIG. 10 is a block diagram of the incubator circuitry in accordance with the present disclosure. Control circuitry 97 is coupled to a plurality of inputs such as oxygen sensor 94, heater-mounted temperature sensor 95, incubator air temperature sensor 105, infant core temperature probe 107, infant peripheral temperature probe 109, air-flow sensor 110 and the like. Furthermore, control circuitry 97 is coupled to control panel 119 which couples inputs such as user interface push-buttons 117 to the control circuitry 97. The control panel 119 includes outputs such as LCD temperature measurement display 113, LCD temperature set point display 115 and a plurality of LED indicators 121 including but not limited to “power present”, “power source”, “system fault”, “display toggle”, and “temperature limits exceeded”. The control circuitry 97 is additional coupled to a plurality of outputs such as power supply fan 99, infant ventilation fan 101 and DC heating elements 103. A heater-mounted thermal cutoff 111 is also provided and coupled to the DC heating elements 103.

FIG. 11A shows the heat flow throughout the infant incubator. An inlet fan 123 is disposed in one end of the base 115 adjacent to heating element 125. A convection channel 127 runs along the back side (and the front side) of the incubator. An opening 131 is provided to let the heat flow into the infant incubator, where arrows 129 illustrate how the heat rises into the hood where it then circulates out to the sides of the hood. The heat leaves the incubator through the portholes 19 at its four corners.

FIG. 11B illustrates another embodiment of the heat flow throughout the infant incubator. A removable heating element 126 made up of a coil that uses at least one fan to force the heat up into the main cavity 128 of the incubator 124 where the infant is located. The heating element is in a low-volume chamber whose walls are insulated and reflective, preventing unnecessary heat loss. Heat escapes the heating element by two means: conduction and radiation. Insulated walls remove all thermally conductive paths, except conduction to the incoming air. Reflective walls bounce the electrically-generated infrared radiation back onto the heating element. As a result, the temperature of the heating element rises quickly, using little power. In an alternative embodiment, incoming air is held in contact with the heating element by a winding path of baffles. This allows the heating element to operate at a lower temperature (and therefore lower power) because the heating element has more time to conduct heat to the air. This goes hand-in-hand with minimizing air flow, which is accomplished by reducing the volume of the incubator air by adjusting the height of the hood via the central support member. Collapsing the incubator hood to its minimum volume allows the inlet fan to operate at a lower speed, decreasing air velocity across the heating element.

Furthermore, the heat in the main volume of the incubator can be recycled back through a secondary opening 130 of the base 15 and brought back to the heating element 126 through a lower channel 132 located at the bottom of the incubator base underneath the main incubator cavity 128 enabling the heating element to operate at a lower temperature to conserve power.

FIG. 12 shows the replaceable electronic card feature of infant incubator 10. Section 132 is a detail showing the removable heating element 134 and section 135 is a detail showing the right side where the electronics are housed. Heating element 134 is located on a bottom side 139 of the base. Card 137 is the motherboard which can be pulled out from the incubator. The electronic card 137 has an indicator LED at its side to show whether or not that particular PCB needs to be replaced. It is to be appreciated that the incubator may include a plurality of modular, replaceable electronic cards in which each card will have a separate LED to show if that particular board has a malfunction. For example, card 138 includes all the electronics for operation of the control panel. In one embodiment, the electronics for a power supply may be disposed on a single removable board. By configuring all the electronics on removable boards or cards, any malfunction or failure can be rectified by simply replacing the bad card with no training or technical knowledge required on the part of the user.

In other embodiments, the power supply will be provided external from the base, e.g., a self-contained power supply cord with the electronics disposed in a brick and the appropriate cord and connectors.

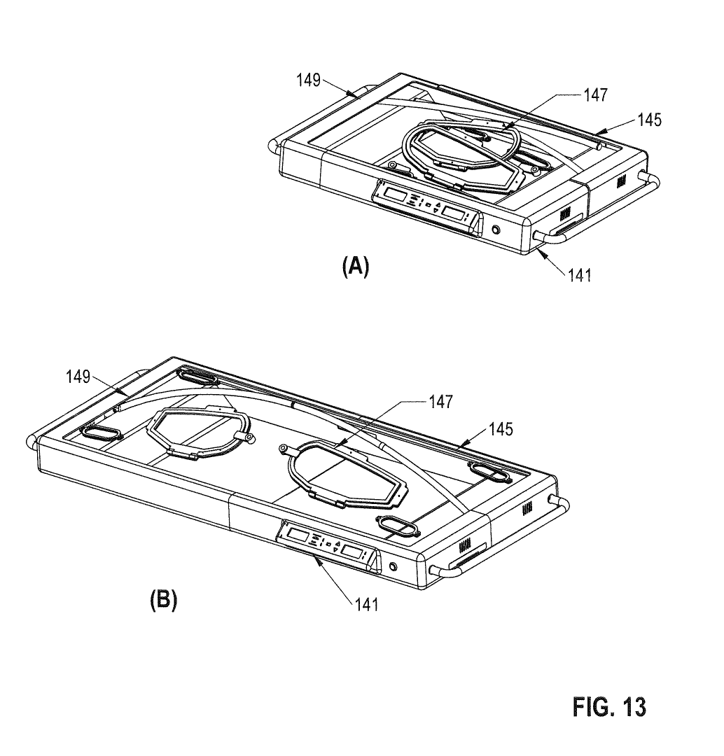

In a further embodiment of the present disclosure, FIG. 13 illustrates an incubator having a base that includes a first portion and a second portion, where the first portion slides into the second portion is a first, non-operational position and the first portion fully extends from the second portion in a second operational position. FIG. 13A shows the infant incubator in a fully closed, non-operational position and FIG. 13B shows the infant incubator in an open operational position. In this embodiment, the base of the infant incubator includes at least two portions which are configured to slide into each other when not in use. The left half 149 of the base slides into sections 141 and 145, which are the two sections of the right half of the infant incubator. Sections 141 and 145 are configured to receive complementary portions of the left half portion 149 of the base. When in the non-operational position, the hood 147 can be folded up, along with all of its attached components including the handholes and portholes, and stored in the contracted base as shown in FIG. 13A.

Referring to FIGS. 14A-C, the central support member 13 is configured for adjusting the hood 11 in a plurality of positions relative to the base 15. The central support member 13 includes a telescoping semi-flexible tube 155 made up of a plastic material, such as delrin, which has a smaller diameter and is situated inside and between two aluminum central support member tubes 157, 159 which are attached to the end-joints at the sides of the infant incubator 10. An aluminum central support member tube 157 located at the right side of the incubator 10, which upon being rotated upward, allows for a greater volume inside the incubator, forcing the internal tube to be telescope out, which ultimately forces the full assembly upward and the hood, e.g., a DEHP-free vinyl, to be readjusted while remaining taught from extension spring located below the base-plate portion, as shown in FIG. 14A. This position of the central support member 13 and hood is optimal for when a physician is attending to the infant inside the incubator. In FIG. 14B, the telescoping internal tube 155 is shown in a partially expanded position. The aluminum central support tube 157 located at the right side is shown in a partially expanded position. In FIG. 14C, the aluminum central support tube 159 located at the left side is shown in a fully closed position and the aluminum central support tube 157 located at the right side is shown in a fully closed position. When the incubator is set to the position shown in FIG. 14C, the internal cavity of the incubator will be at a low volume which will facilitate heating of the air. Since the air will be heated in a shorter period of time due to the low volume, less power will be consumed.

Although the disclosure herein has been described with reference to particular illustrative embodiments, it is to be understood that these embodiments are merely illustrative of the principles and applications of the present disclosure. Therefore numerous modifications may be made to the illustrative embodiments and other arrangements may be devised without departing from the spirit and scope of the present disclosure, which is defined by the appended claims.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

What is claimed is:

1. A neonatal intensive care system comprising:
an infant incubator comprising:
a base configured for supporting an infant, the base defining a low profile volume including an open top; and
an adjustable hood coupled over the open top of the base, wherein in one position the hood collapses completely into the base.

2. The system as in claim 1, wherein the incubator further comprising a central support member coupled to at least two portions of the base configured for supporting the hood in a curvilinear shape, the central support member configured for adjusting the hood in a plurality of positions relative to the base.

3. The system as in claim 2, wherein the hood is formed from a flexible material.

4. The system as in claim 3, wherein the flexible material is vinyl.

5. The system as in claim 2, wherein the hood includes a door formed from a rigid material.

6. The system as in claim 5, wherein the rigid material is an acrylic or resin.

7. The system as in claim 5, wherein the door includes at least one handhole.

8. The system as in claim 1, wherein the base includes a modular, removable heating element for generating heat.

9. The system as in claim 8, wherein the base includes a low volume chamber for receiving the modular heating element, the chamber being formed from insulated and reflective walls to prevent heat loss.

10. The system as in claim 8, wherein the base further includes a channel for recycling heat from the incubator back to the heating element.

11. The system as in claim 8, wherein the base further comprises a modular, removable temperature control interface for controlling the temperature of the incubator.

12. The system as in claim 11, further comprising a uninterruptible power supply (UPS) for providing power to the heating element and the temperature control interface.

13. The system as in claim 1, wherein the base includes a portion storing a phase change material (PCM) for supplying heat to the incubator upon loss of power being provided.

14. The system as in claim 1, wherein the base includes a first portion and a second portion, the first portion slides into the second portion is a first, non-operational position and the first portion fully extends from the second portion in a second operational position.

15. The system as in claim 1, further comprising a frame for transporting the incubator, the frame including a support member positioned at a top portion of the frame for supporting the incubator.

16. The system as in claim 15, further comprising a bassinet, wherein the support member of the frame is further configured to support the bassinet in various positions when the incubator is not in use.

17. An infant incubator comprising:
a generally rectangular base configured for supporting an infant, the base including a bottom wall and at least three side walls defining a low profile volume including an open top;
a hood coupled over the open top of the base configured from a flexible material; and
a central support member coupled to at least two portions of the base configured for supporting the hood in a curvilinear shape, the central support member configured for adjusting the hood in a plurality of positions relative to the base, wherein in one position the hood and central support member collapses completely into the base.

18. The incubator as in claim 17, wherein the base further comprises:
a low volume chamber for receiving a modular heating element, the chamber being formed from insulated and reflective walls to prevent heat loss; and
a channel for recycling heat from an internal cavity of the incubator back to the heating element in the chamber enabling the heating element to operate at a lower temperature to conserve power.

19. The incubator as in claim 18, wherein the hood further comprises a door formed from a rigid material rotatably coupled to the central support member by at least one hinge.

20. The incubator as in claim 19, further comprising a control interface disposed on the base for controlling functions of the incubator, wherein each function is illustrated by a non-text graphic.
